(19) United States
(12) Patent Application Publication
(10) Pub. No.: US 2014/0074457 A1
(43) Pub. Date: Mar. 13, 2014

(54) REPORT GENERATING SYSTEM, NATURAL LANGUAGE PROCESSING APPARATUS, AND REPORT GENERATING APPARATUS

(71) Applicant: Yusaku Masuda, Kanagawa (JP)

(72) Inventor: Yusaku Masuda, Kanagawa (JP)

(21) Appl. No.: 14/012,091

(22) Filed: Aug. 28, 2013

(30) Foreign Application Priority Data
Sep. 10, 2012 (JP) 2012-198957

(51) Int. Cl. G06F 17/24

(52) U.S. Cl. CPC G06F 17/24
USPC 704/9

(57) ABSTRACT

A report generating system includes a service information acquiring unit that acquires service information, a natural language processing unit that performs natural language processing on the acquired service information to extract a word, a replacing unit that replaces the word extracted from the service information with word identification information by referring to a word list in which the word and the word identification information are associated, a word identification information output unit that outputs the replaced word identification information, a word identification information acquiring unit that acquires the output word identification information, a counting unit that counts a total number of pieces of word identification information with a same value among acquired pieces of the word identification information, for each of values of the pieces of the word identification information, a generating unit that generates a report based on a counting result.

### CROSS-REFERENCE TO RELATED APPLICATIONS

The present application claims priority to and incorporates by reference the entire contents of Japanese Patent Application No. 2012-198957 filed in Japan on Sep. 10, 2012.

### BACKGROUND OF THE INVENTION

1. Field of the Invention

The present invention relates to a report generating system, a natural language processing apparatus, and a report generating apparatus.

2. Description of the Related Art

A service provider who provides services related to electronic devices installs a device management system or a service desk system in each of service locations. The device management system mainly manages the usage or malfunction of electronic devices in the service location by using a numeric value. For example, the device management system manages, as device information, a counter value, a power consumption value, and a supply remaining level. The service desk system manages details of failures that occur in the electronic devices in the service location by using text and a numeric value. For example, the service desk system manages, as service information, details of a failure, details of a cause, details of troubleshooting, an occurrence date and time, a failure recovery time, and a continuous operating time.

For example, Japanese Patent Application Laid-open No. 2001-320370 discloses a technology for generating a report on the service quality based on alert information collected from network devices, service configuration information, and service level agreement information on the service quality agreed by a customer.

However, in the conventional technology, while the service information is used for the report, only numerical information that can easily be aggregated is used for the report and text information that is difficult to aggregate is not used for the report.

Therefore, it is desirable to provide a report generating system, a natural language processing apparatus, and a report generating apparatus capable of generating a report by using the service information represented by text.

### SUMMARY OF THE INVENTION

It is an object of the present invention to at least partially solve the problems in the conventional technology.

According to an aspect of the present invention, there is provided a report generating system including: a service information acquiring unit that acquires service information that is text information on a customer service; a natural language processing unit that performs natural language processing on the acquired service information to extract a word; a replacing unit that replaces the word extracted from the service information with word identification information by referring to a word list in which the word and word identification information for identifying the word are associated with each other; a word identification information output unit that outputs the replaced word identification information; a word identification information acquiring unit that acquires the output word identification information; a counting unit that counts a total number of pieces of word identification information with a same value among acquired pieces of the word identification information, for each of values of the pieces of the word identification information; a generating unit that generates a report based on a counting result; and a report output unit that outputs the generated report.

According to another aspect of the present invention, there is provided a natural language processing apparatus including: a service information acquiring unit that acquires service information that is text information on a customer service; a natural language processing unit that performs natural language processing on the acquired service information to extract a word; a replacing unit that replaces the word extracted from the service information with word identification information by referring to a word list in which the word and the word identification information for identifying the word are associated with each other; and a word identification information output unit that outputs the replaced word identification information.

According to still another aspect of the present invention, there is provided a report generating apparatus including: a word identification information acquiring unit that acquires word identification information for identifying a word extracted from service information that is text information on a customer service; a counting unit that counts a total number of pieces of word identification information with a same value among acquired pieces of the word identification information, for each of values of the pieces of the word identification information; a generating unit that generates a report based on a counting result; and a report output unit that outputs the generated report.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is block diagram illustrating a configuration example of a system according to an embodiment;

FIG. 2 is a block diagram illustrating a configuration example of a natural language processing apparatus according to the embodiment;

FIG. 3 is a diagram illustrating an example of a language list according to the embodiment;

FIG. 4 is a diagram illustrating an example of a word list according to the embodiment;

FIG. 5 is a block diagram illustrating a configuration example of a report generating apparatus according to the embodiment;

FIG. 6 is a diagram illustrating an example of information stored in a word ID storage unit according to the embodiment;

FIG. 7 is a diagram illustrating an example of a report generated by the generating unit according to the embodiment;

FIG. 8 is a diagram illustrating another example of a report generated by the generating unit according to the embodiment;

FIG. 9 is a flowchart illustrating an example of a process performed by the natural language processing apparatus according to the embodiment;

FIG. 10 is a flowchart illustrating an example of a process performed by the report generating apparatus according to the embodiment; and

FIG. 11 is a block diagram illustrating an example of a hardware configuration of each of the apparatuses according to the embodiment and modifications.

### DETAILED DESCRIPTION OF THE PREFERRED EMBODIMENTS

Exemplary embodiments of the present invention will be explained in detail below with reference to the accompanying drawings.

A configuration of a report generating system according to an embodiment will be explained below.

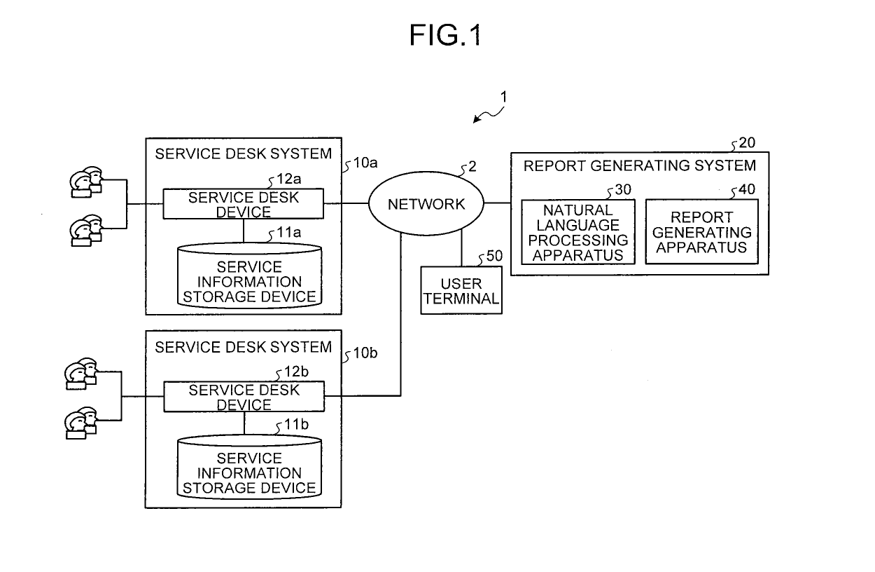

FIG. 1 is a block diagram illustrating a configuration example of a system 1 according to the embodiment. As illustrated in FIG. 1, the system 1 includes service desk systems 10a and 10b, a report generating system 20, and a user terminal 50. The service desk systems 10a and 10b, the report generating system 20, and the user terminal 50 are connected to one another via a network 2. The network 2 is implemented by, for example, the Internet or a leased line.

Hereinafter, it is assumed that the service desk system 10a is installed in a location a and the service desk system 10b is installed in a location b. In the embodiment, it is assumed that the locations a and b are different regions employed by the same customer. However, the present invention is not limited to this example. Herein, the region is a concept including a country. In the example illustrated in FIG. 1, two service desk systems are provided. However, the present invention is not limited to this example, and the number of the service desk systems may be arbitrary.

Each of the service desk systems 10a and 10b is a database system for managing service information on a customer service provided to a device (not illustrated) installed in each of the locations a and b. Examples of the device include an image forming apparatus, such as a printer, a copier, a multifunction peripheral (MFP), a scanner, and a facsimile machine; various electronic devices, such as a projector, a camera, an air conditioner, a refrigerator, a fluorescent light, an automatic vending machine, and a handheld terminal; and an information processing apparatus, such as a personal computer (PC). The MFP is a device including at least two of a copying function, a printing function, a scanning function, and a facsimile function.

Specifically, the service information represents, by text and numeric values, details of a failure that has occurred in the device or details of troubleshooting performed on the failure by a service engineer. Examples of the service information include details of a failure, details of a cause, details of troubleshooting, an occurrence date and time, a failure recovery time, and a continuous operating time. In the embodiment, a specific example will be explained in which the service information is represented as text information, such as details of a failure, details of a cause, or details of troubleshooting. However, the present invention is not limited to this example and the service information may be represented by a numeric value.

The service desk system 10a includes a service information storage device 11a and a service desk device 12a. The service information storage device 11a is a database for accumulating pieces of service information on devices installed in the location a. The service desk device 12a is a normal computer, such as a server device. The service information on each of the devices installed in the location a is input to the service desk device 12a by a responsible person or a service engineer of the service desk system 10a through an input device (not illustrated), and the service desk device 12a registers the service information in the service information storage device 11a.

The service desk system 10b includes a service information storage device 11b and a service desk device 12b. The service information storage device 11b is a database for accumulating pieces of service information on devices installed in the location b. The service desk device 12b is a normal computer, such as a server device. The service information on each of the devices installed in the location b is input to the service desk device 12b by a responsible person or a service engineer of the service desk system 10b through an input device (not illustrated), and the service desk device 12b registers the service information in the service information storage device 11b.

As described above, in the service desk systems 10a and 10b, the service information is registered manually.

The user terminal 50 is a terminal device of a customer or a service provider, and issues a report generation request to the report generating system 20 via a browser displayed on a display device (not illustrated). The user terminal 50 acquires a report generated by the report generating system 20 and displays the acquired report on the browser.

The report generating system 20 generates a report on each of the devices installed in the locations a and b according to a request from the user terminal 50. The report generating system 20 includes a natural language processing apparatus 30 and a report generating apparatus 40.

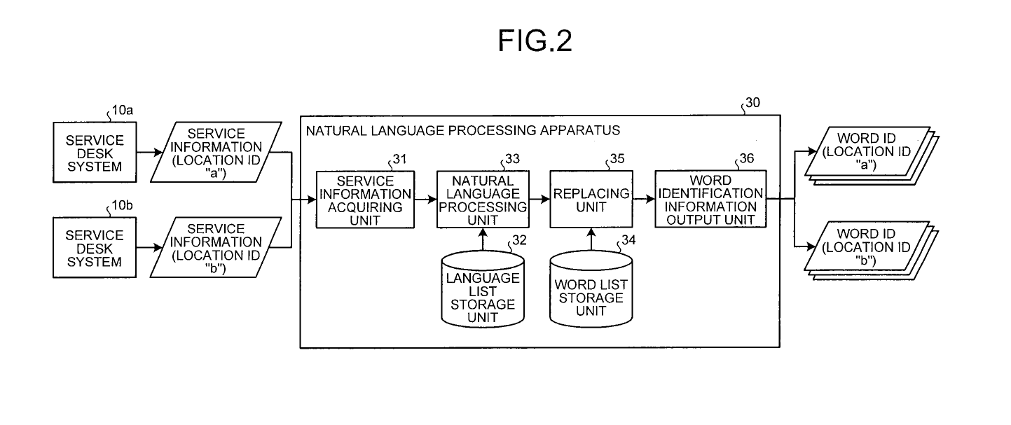

FIG. 2 is a block diagram illustrating a configuration example of the natural language processing apparatus 30 according to the embodiment. As illustrated in FIG. 2, the natural language processing apparatus 30 includes a service information acquiring unit 31, a language list storage unit 32, a natural language processing unit 33, a word list storage unit 34, a replacing unit 35, and a word identification information output unit 36.

The service information acquiring unit 31, the natural language processing unit 33, the replacing unit 35, and the word identification information output unit 36 may be implemented by, for example, a control device, such as a central processing unit (CPU). The language list storage unit 32 and the word list storage unit 34 may be implemented by a storage device, such as a hard disk drive (HDD), a solid state drive (SSD), a memory card, an optical disk, a read only memory (ROM), or a random access memory (RAM), capable of storing data magnetically, optically, or electrically.

The service information acquiring unit 31 acquires the service information. Specifically, the service information acquiring unit 31 acquires the service information and a location ID (an example of location identification information) for identifying a service location in which a customer service indicated by the service information is provided. Specifically, in the embodiment, the service information acquiring unit 31 acquires the service information on the service desk system 10a together with a location ID “a” of the location a, and acquires the service information on the service desk system 10b together with a location ID “b” of the location b. In the embodiment, the service information acquiring unit 31 acquires the service information and the location ID from each of the service desk systems 10a and 10b with a predetermined period. However, the acquisition timing is not limited to this example.

For example, the service information acquiring unit 31 acquires, from the service desk system 10a, service information of “troubleshooting for paper jam in the printing apparatus x and troubleshooting for paper jam in the printing apparatus y are performed” and the location ID “a”. For another example, the service information acquiring unit 31 acquires, from the service desk system 10b, service information of “toner end is detected by examination due to occurrence of a service call in the multifunction peripheral (MFP) z” and the location ID “b”.

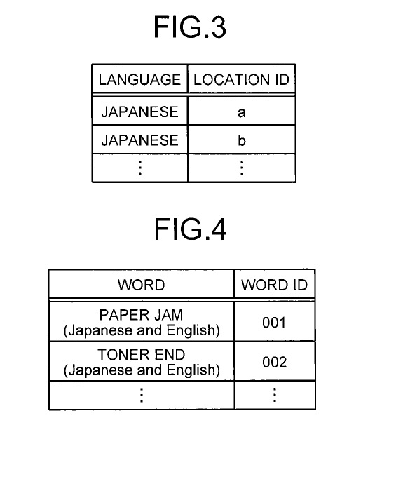

The language list storage unit 32 stores therein a language list, in which a language and the location ID are associated with each other. FIG. 3 is a diagram illustrating an example of the language list according to the embodiment. In the example illustrated in FIG. 3, Japanese is associated with both of the location IDs “a” and “b”.

The natural language processing unit 33 performs natural language processing on the service information acquired by the service information acquiring unit 31, and extracts a word. Specifically, the natural language processing unit 33 performs a morphological analysis on the service information acquired by the service information acquiring unit 31 by referring to dictionary data (not illustrated) and extracts a word. As the dictionary data, a word list stored in a word list storage unit 34 (to be described later) may be used.

For example, the natural language processing unit 33 performs the natural language processing on the service information of “troubleshooting for paper jam in the printing apparatus x and troubleshooting for paper jam in the printing apparatus y are performed”, and extracts words “printing apparatus x”, “paper jam”, “troubleshooting”, “printing apparatus y”, “paper jam”, and “troubleshooting”. For another example, the natural language processing unit 33 performs the natural language processing on the service information of “toner end is detected by examination due to occurrence of a service call in the multifunction peripheral (MFP) z”, and extracts words “multifunction peripheral (MFP) z”, “service call”, “occurrence”, “examination”, and “toner end”.

The natural language processing unit 33 performs the natural language processing on the acquired service information in accordance with a language based on the acquired location ID. Specifically, the natural language processing unit 33 performs, on the acquired service information, natural language processing corresponding to a language associated with the acquired location ID by referring to the language list stored in the language list storage unit 32.

In the embodiment, the locations a and b are Japanese-speaking countries, and Japanese is associated with both of the location IDs in the language list. Therefore, the natural language processing unit 33 performs natural language processing corresponding to Japanese on the service information. However, if a location indicated by the location ID is an English-speaking country and English is associated with the location ID in the language list, the natural language processing unit 33 performs natural language processing corresponding to English on the service information.

The word list storage unit 34 stores therein the word list, in which a word and a word ID (an example of word identification information) for identifying the word are associated with each other. Specifically, in the embodiment, a word in the word list is expressed in a plurality of languages. FIG. 4 is a diagram illustrating an example of the word list according to the embodiment. In the example illustrated in FIG. 4, word IDs “001” and “002” are associated with words “paper jam” and “toner end”, respectively, and each of the words is expressed in Japanese and English.

The replacing unit 35 replaces a word extracted from the service information by the natural language processing unit 33 with a word ID by referring to the word list stored in the word list storage unit 34. For example, the replacing unit 35 refers to the word list and replaces the word “paper jam” with the word ID “001” and replaces the word “toner end” with the word ID “002” among the words “printing apparatus x”, “paper jam”, “troubleshooting”, “printing apparatus y”, “paper jam”, “troubleshooting”, “multifunction peripheral (MFP) z”, “service call”, “occurrence”, “examination”, and “toner end” extracted by the natural language processing unit 33.

The word identification information output unit 36 outputs the word ID replaced by the replacing unit 35. Specifically, the word identification information output unit 36 outputs the word ID replaced by the replacing unit 35 and the location ID acquired by the service information acquiring unit 31 to the report generating apparatus 40 in an associated manner.

For example, two words “paper jam” are replaced with the word IDs “001” for the service information acquired from the service desk system 10a, and the word identification information output unit 36 associates the location ID “a” with both of the two word IDs “001” and outputs them to the report generating apparatus 40. For another example, the word “toner end” is replaced with the word ID “002” for the service information acquired from the service desk system 10b, and the word identification information output unit 36 associates the location ID “b” with the word ID “002” and outputs them to the report generating apparatus 40.

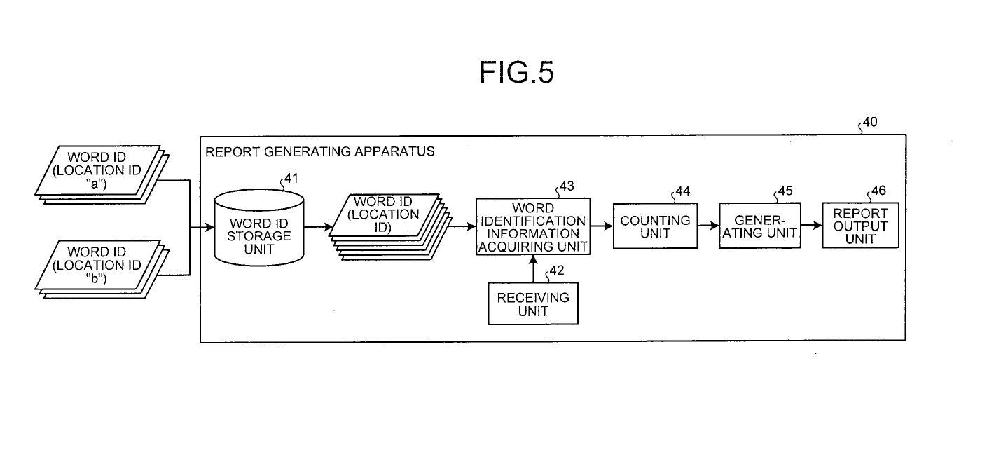

FIG. 5 is a block diagram illustrating a configuration example of the report generating apparatus 40 according to the embodiment. As illustrated in FIG. 5, the report generating apparatus 40 includes a word ID storage unit 41, a receiving unit 42, a word identification information acquiring unit 43, a counting unit 44, a generating unit 45, and a report output unit 46.

The word ID storage unit 41 may be implemented by at least any of storage devices such as an HDD, an SSD, a memory card, an optical disk, a ROM, and a RAM capable of storing data magnetically, optically, or electrically. The receiving unit 42, the word identification information acquiring unit 43, the counting unit 44, the generating unit 45, and the report output unit 46 may be implemented by a control device, such as a CPU.

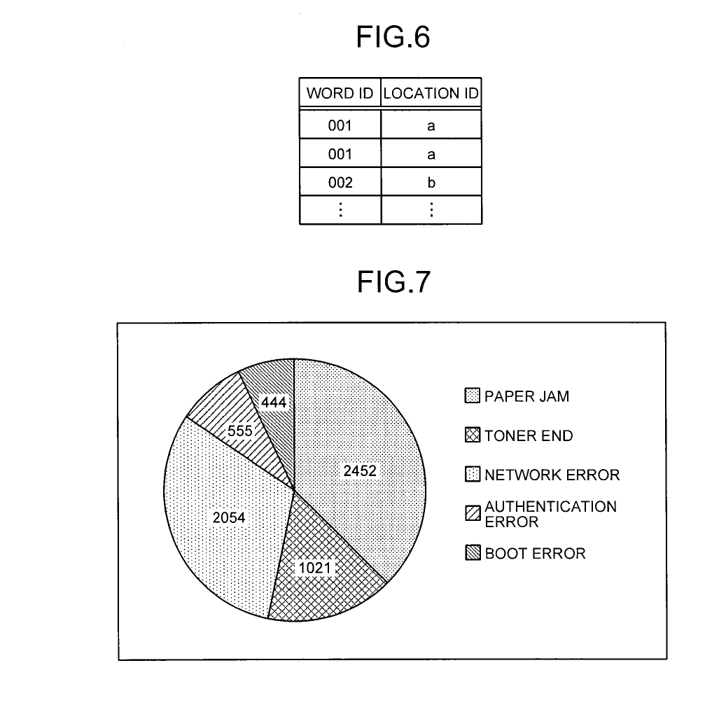

The word ID storage unit 41 stores therein the word ID output by the natural language processing apparatus 30. Specifically, the word ID storage unit 41 stores therein the word ID and the location ID that are output by the natural language processing apparatus 30 in an associated manner. FIG. 6 is a diagram illustrating an example of information stored in the word ID storage unit 41 according to the embodiment. For example, as illustrated in FIG. 6, the word ID storage unit 41 stores a pair of the word ID “001” and the location ID “a”, a pair of the word ID “001” and the location ID “a”, and a pair of the word ID “002” and the location ID “b”.

The receiving unit 42 receives item type information indicating a type of a report generation item and area type information indicating a type of a report generation area. Specifically, the receiving unit 42 receives, from the user terminal 50, the item type information and the area type information as a report generation request when a report is to be generated. The type of the report generation item is, for example, a type of an error. The type of the report generation area is, for example, a type of a service location. However, the present invention is not limited to this example.

In the embodiment, the item type information is designated by the word ID, and the area type information is designated by the location ID. However, the present invention is not limited to this example. Specifically, the item type information may be any information corresponding to the word ID stored in the word ID storage unit 41, that is, any information that can designate the word ID stored in the word ID storage unit 41. Furthermore, the area type information may be any information corresponding to the location ID stored in the word ID storage unit 41, that is, any information that can designate the location ID stored in the word ID storage unit 41.

The word identification information acquiring unit 43 acquires the word ID. Specifically, the word identification information acquiring unit 43 acquires the word ID and the location ID associated with the word ID from the word ID storage unit 41. In particular, the word identification information acquiring unit 43 acquires a pair of the word ID that corresponds to a value indicated by the item type information received by the receiving unit 42 and the location ID that is associated with the word ID and that corresponds to a value indicated by the area type information received by the receiving unit 42.

For example, when the receiving unit 42 receives the item type information for designating all of the items and the area type information for designating the location a, the word identification information acquiring unit 43 acquires a pair of the word ID “001” and the location ID “a” and a pair of the word ID “001” and the location ID “a” from the word ID storage unit 41.

For another example, when the receiving unit 42 receives the item type information for designating paper jam and the area type information for designating all of the locations, the word identification information acquiring unit 43 acquires a pair of the word ID “001” and the location ID “a”, and a pair of the word ID “001” and the location ID “a” from the word ID storage unit 41.

The counting unit 44 counts the total number of word IDs with the same value from among the word IDs acquired by the word identification information acquiring unit 43, for each of the values of the word IDs. Specifically, the counting unit 44 counts the total number of pairs of the word ID and the location ID with the same value from among the acquired pairs of the word ID and the location ID, for each of the values of the pairs of the word ID and the location ID.

For example, when the word identification information acquiring unit 43 acquires a pair of the word ID “001” and the location ID “a” and a pair of the word ID “001” and the location ID “a”, the counting unit 44 counts the total number of the pairs of the word ID “001” and the location ID “a” as two.

For another example, when the word identification information acquiring unit 43 acquires a pair of the word ID “001” and the location ID “a”, a pair of the word ID “001” and the location ID “a”, and a pair of the word ID “002” and the location ID “b”, the counting unit 44 counts the total number of the pairs of the word ID “001” and the location ID “a” as two and counts the total number of the pairs of the word ID “002” and the location ID “b” as one.

The generating unit 45 generates a report based on a counting result obtained by the counting unit 44. The generating unit 45 may generate a report by using the counting result obtained by the counting unit 44 as it is, or may generate a report by processing the counting result obtained by the counting unit 44.

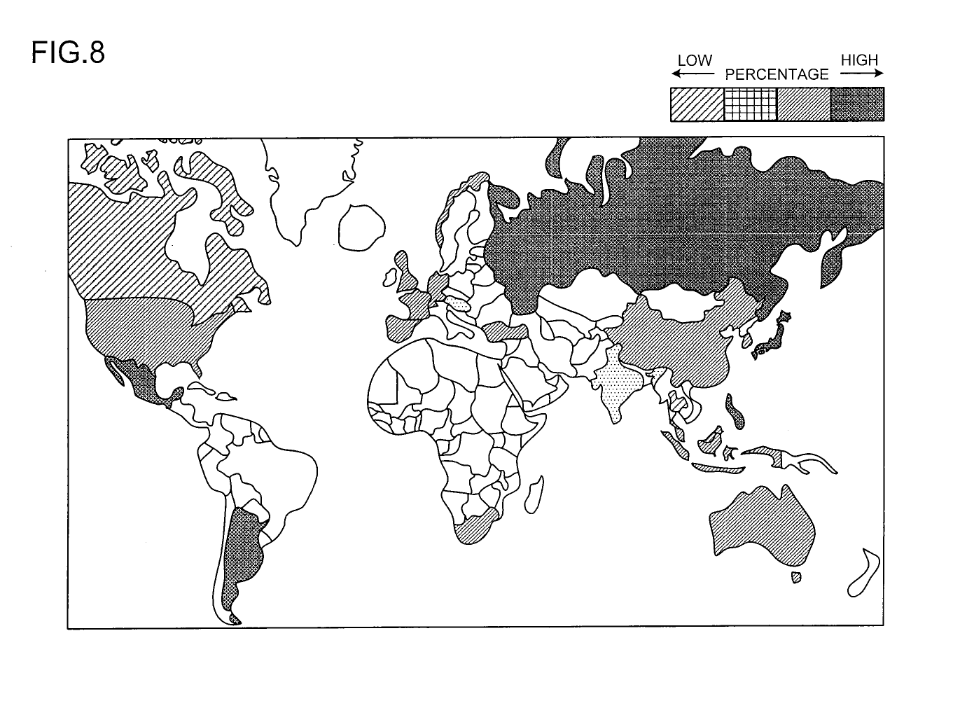

FIGS. 7 and 8 are diagrams illustrating examples of reports generated by the generating unit 45 according to the embodiment. Specifically, FIG. 7 illustrates a service report generated when the receiving unit 42 receives the item type information for designating all of the items and the area type information for designating the location a, and FIG. 8 illustrates a service report generated when the receiving unit 42 receives the item type information for designating paper jam and the area type information for designating all of the locations.

The service report illustrated in FIG. 7 contains a circle graph of the counting results obtained by the counting unit 44 with respect to the error items such as paper jam, toner end, network error, authentication error, and boot error in the location a. For example, the value of the paper jam is 2452. Incidentally, 2452 indicates the total number of the pairs of the word ID “001” and the location ID “a” counted by the counting unit 44.

The service report illustrated in FIG. 8 contains the counting results obtained by the counting unit 44 with respect to the error item of paper jam in all of the locations, while the counting results are represented by percentages for each of countries (regions) involving the locations and are displayed on a world map. The example illustrated in FIG. 8 shows that the frequency of the paper jam is high in Japan and Russia (the total number of the pairs of the location ID of each of Japan and Russia and the word ID “001” is large), and the frequency of the paper jam in North America is low (the total number of the pairs of the location ID of North America and the word ID “001” is small).

The report output unit 46 outputs the report generated by the generating unit 45. Specifically, the report output unit 46 outputs the report generated by the generating unit 45 to the user terminal 50.

Operation of the report generating system according to the embodiment will be explained below.

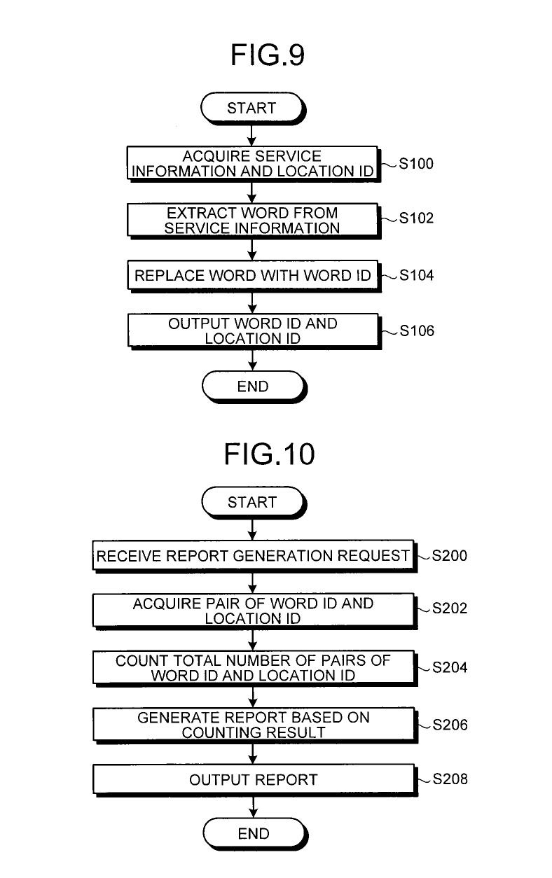

FIG. 9 is a flowchart illustrating an example of a process performed by the natural language processing apparatus 30 according to the embodiment.

The service information acquiring unit 31 acquires, from the service desk system, service information and a location ID for identifying a service location in which a customer service indicated by the service information is provided (Step S100).

The natural language processing unit 33 performs the natural language processing on the service information acquired by the service information acquiring unit 31, and extracts a word (Step S102).

The replacing unit 35 replaces the word extracted from the service information by the natural language processing unit 33 with a word ID by referring to the word list stored in the word list storage unit 34 (Step S104).

The word identification information output unit 36 associates the word ID replaced by the replacing unit 35 with the location ID acquired by the service information acquiring unit 31, and outputs the associated word ID and location ID to the report generating apparatus 40 (Step S106).

FIG. 10 is a flowchart illustrating an example of a process performed by the report generating apparatus 40 according to the embodiment.

The receiving unit 42 receives, from the user terminal 50, the item type information and the area type information as a report generation request when a report is to be generated (Step S200).

The word identification information acquiring unit 43 acquires a pair of the word ID that corresponds to a value indicated by the item type information received by the receiving unit 42 and the location ID that is associated with the word ID and that correspond to a value indicated by the area type information received by the receiving unit 42, from the word ID storage unit 41 that stores therein the word ID and location ID output by the natural language processing apparatus 30 in an associated manner (Step S202).

The counting unit 44 counts the total number of pairs of the word ID and the location ID with the same value from among the acquired pairs of the word ID and the location ID, for each of the values of the pairs of the word ID and the location ID (Step S204).

The generating unit 45 generates a report based on the counting result obtained by the counting unit 44 (Step S206).

The report output unit 46 outputs the report generated by the generating unit 45 to the user terminal 50 (Step S208).

As described above, according to the embodiment, words are extracted from the service information represented by text, the extracted words are replaced with word IDs, a total number of the word IDs with the same value is counted, and a report is generated based on the counting result. Therefore, it becomes possible to generate a report by using the service information represented by text for which it is difficult to form a predetermined format.

Furthermore, according to the embodiment, words are extracted from the service information by performing the natural language processing corresponding to a language based on the location ID, and words that have the same meaning but written in different languages are replaced with the same word ID. Therefore, it becomes possible to cope with a difference between languages of the text, enabling to generate a global report or the like.

In particular, according to the embodiment, the service information represented by text is replaced with the word ID represented by a numeric value or the like to generate a report. Therefore, it becomes possible to generate the report in a shorter time regardless of the amount of data in text (the service information). Consequently, it becomes possible to generate a global report or the like that inevitably involves a large amount of data, in a shorter time.

As described above, according to the embodiment, it is possible to generate a report by aggregating pieces of data represented in a text format that has high information value to continue a service. Therefore, it becomes possible to generate a report that enables to identify a primary cause or to find a solution of service quality issues.

Modification

The present invention is not limited to the above embodiment, and may be modified in various forms.

First Modification

In the embodiment, it is explained that the service information is represented by text. However, the present invention may be applied when the service information is represented by a numeric value instead of text. Furthermore, although it is not explained in the above embodiment, it may be possible to generate a report by adding device information, such as a counter value, a power consumption value, or a supply remaining level, managed by a device management system that mainly manages the usage or malfunction of electronic devices in the service location.

In this case, it is sufficient that the counting unit 44 further counts the value contained in the service information and the value contained in the device information. For example, if the number of paper jams in the location a is represented by a value “100” in the service information, and the number of paper jams in the location a is represented by “50” in the device information, “100” and “50” are added to the number of paper jams in the location a (the total number of the pairs of the word ID “001” and the location ID “a”) counted by the counting unit 44.

Second Modification

In the embodiment, an example is explained that a report is generated in accordance with the contents of the item type information and the area type information designated by the user terminal 50. However, the present invention is not limited to the above embodiment. For example, it may be possible to generate a report on all of the items and all of the locations such that a display format of the report is changed according to user operation. For example, when the location a in Japan is selected in the report illustrated in FIG. 8, it may be possible to drill down to the location a and change a report to be displayed to the report illustrated in FIG. 7.

Third Modification

In the embodiment, an example is explained that the report generating system 20 includes the natural language processing apparatus 30 and the report generating apparatus 40. However, the present invention is not limited to the above embodiment. For example, the report generating system 20 may be configured as a device, in particular, a single device, including the components of the natural language processing apparatus 30 and the report generating apparatus 40. For another example, at least a part of the components of the natural language processing apparatus 30 may be provided in the report generating apparatus 40 or other devices, or at least a part of the components of the report generating apparatus 40 may be provided in the natural language processing apparatus 30 or other devices.

Fourth Modification

In the embodiment, an example is explained that the language list storage unit 32 stores the language list, the word list storage unit 34 stores the word list, and the word ID storage unit 41 stores the word ID or the like replaced from a word. However, at least a part of the above pieces of information may be stored in an external apparatus (for example, on the cloud).

Hardware Configuration

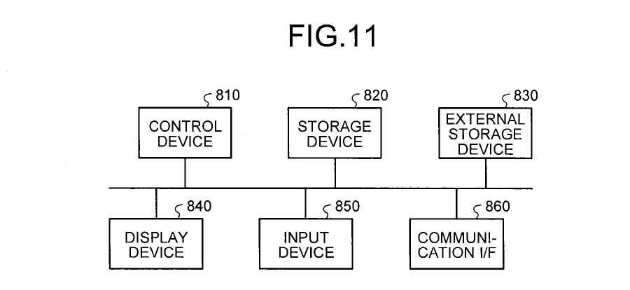

FIG. 11 is a diagram illustrating an example of a hardware configuration of the service desk systems 10a and 10b, the natural language processing apparatus 30, the report generating apparatus 40, and the user terminal 50 according to the embodiment and the modifications (hereinafter, referred to as each of the devices of the embodiment and the modifications). As illustrated in FIG. 11, each of the devices of the embodiment and the modifications includes a control device 810, such as a CPU, a storage device 820, such as a ROM or a RAM, an external storage device 830, such as a HDD, a display device 840, such as a display, an input device 850, such as a keyboard or a mouse, and a communication device 860, such as a communication interface, and has a hardware configuration using a normal computer.

A program executed by each of the devices of the embodiment and the modifications is provided by being stored in a computer readable storage medium, such as a compact disc-ROM (CD-ROM), a compact disc-recordable (CD-R), a memory card, a digital versatile disk (DVD), or a flexible disk (FD), in a computer-installable or computer-executable file format.

Furthermore, the program executed by each of the devices of the embodiment and the modifications may be stored in a computer connected to a network, such as the Internet, and be provided by downloading via the network. Moreover, the program executed by each of the devices of the embodiment and the modifications may be provided or distributed via a network, such as the Internet. Furthermore, the program executed by each of the devices of the embodiment and the modifications may be provided by being stored in a ROM or the like in advance.

The program executed by each of the devices of the embodiment and the modifications has a module structure for realizing the above units on a computer. As actual hardware, a CPU reads the program from an HDD onto a RAM and executes the program, so that the above units are realized on the computer.

According to an embodiment of the present invention, it is possible to generate a report by using service information represented by text.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A report generating system comprising:
a service information acquiring unit that acquires service information that is text information on a customer service;
a natural language processing unit that performs natural language processing on the acquired service information to extract a word;
a replacing unit that replaces the word extracted from the service information with word identification information by referring to a word list in which the word and word identification information for identifying the word are associated with each other;
a word identification information output unit that outputs the replaced word identification information;
a word identification information acquiring unit that acquires the output word identification information;
a counting unit that counts a total number of pieces of word identification information with a same value among acquired pieces of the word identification information, for each of values of the pieces of the word identification information;
a generating unit that generates a report based on a counting result; and
a report output unit that outputs the generated report.

2. The report generating system according to claim 1, wherein
the service information acquiring unit further acquires location identification information for identifying a service location in which the customer service indicated by the service information is provided,
the word identification information output unit outputs the replaced word identification information and the acquired location identification information in an associated manner,
the word identification information acquiring unit further acquires the location identification information that is output in association with the output word identification information, and
the counting unit counts a total number of pairs of the word identification information and the location identification information with a same value from among acquired pairs of the word identification information and the location identification information, for each of values of the pairs of the word identification information and the location identification information.

3. The report generating system according to claim 2, further comprising:
a receiving unit that receives item type information indicating a type of a report generation item and area type information indicating a type of a report generation area, wherein
the word identification information acquiring unit acquires a pair of word identification information that corresponds to a value indicated by the item type information and location identification information that is associated with the word identification information and that corresponds to a value indicated by the area type information.

4. The report generating system according to claim 2, wherein the natural language processing unit performs, on the service information, natural language processing corresponding to a language based on the acquired location identification information.

5. The report generating system according to claim 1, wherein the word in the word list is expressed in a plurality of languages.

6. A natural language processing apparatus comprising:
a service information acquiring unit that acquires service information that is text information on a customer service;
a natural language processing unit that performs natural language processing on the acquired service information to extract a word;
a replacing unit that replaces the word extracted from the service information with word identification information by referring to a word list in which the word and the word identification information for identifying the word are associated with each other; and
a word identification information output unit that outputs the replaced word identification information.

7. The natural language processing apparatus according to claim 6, wherein
the service information acquiring unit further acquires location identification information for identifying a service location in which the customer service indicated by the service information is provided, and
the word identification information output unit outputs the replaced word identification information and the acquired location identification information in an associated manner.

8. The natural language processing apparatus according to claim 7, wherein the natural language processing unit performs, on the service information, natural language processing corresponding to a language based on the acquired location identification information.

9. The natural language processing apparatus according to claim 6, wherein the word in the word list is expressed in a plurality of languages.

10. A report generating apparatus comprising:
a word identification information acquiring unit that acquires word identification information for identifying a word extracted from service information that is text information on a customer service;
a counting unit that counts a total number of pieces of word identification information with a same value among acquired pieces of the word identification information, for each of values of the pieces of the word identification information;
a generating unit that generates a report based on a counting result; and
a report output unit that outputs the generated report.

11. The report generating apparatus according to claim 10, wherein
the word identification information is associated with location identification information for identifying a service location in which the customer service indicated by the service information is provided,
the word identification information acquiring unit further acquires the location identification information associated with the word identification information, and
the counting unit counts a total number of pairs of the word identification information and the location identification information with a same value among acquired pairs of the word identification information and the acquired location identification information, for each of values of the pairs of the word identification information and the location identification information.

12. The report generating apparatus according to claim 11, further comprising:
a receiving unit that receives item type information indicating a type of a report generation item and area type information indicating a type of a report generation area, wherein
the word identification information acquiring unit acquires a pair of the word identification information that corresponds to a value indicated by the item type information and the location identification information that is associated with the word identification information and that corresponds to a value indicated by the area type information.
